(19) United States
(12) Patent Application Publication
(10) Pub. No.: US 2003/0186048 A1
(43) Pub. Date: Oct. 2, 2003

(54) Self-adhesive film

(76) Inventors: Reto Sieber, Sigigen (CH); Marco Sieber, Horw (CH)

Correspondence Address: JORDAN AND HAMBURG LLP, 122 EAST 42ND STREET, SUITE 4000, NEW YORK, NY, 10168, US

(21) Appl. No.: 10/362,401

(22) PCT Filed: Jul. 18, 2001
(86) PCT No.: PCT/EP01/08314

(30) Foreign Application Priority Data
Aug. 22, 2000 (DE) 10040966.0

(51) Int. Cl. B32B 7/12

(52) U.S. Cl. 428/343

(57) ABSTRACT

The invention relates to a self-adhesive film for fixing a floor covering, especially a carpet, having an own weight of more than 500 g/m², to a floor, especially parquet or stairs. Said film comprises a carrier layer consisting of a plastic film which is coated with a contact adhesive on an upper surface facing the floor covering, and on a lower surface facing the floor or the stairs. Said film has a minimum breadth of 150 mm in order to be able to cover a large area of the floor or stairs to be covered with the floor covering. The contact adhesive is fixed to at least the lower surface of the carrier layer in such a way that it remains thereon when the self-adhesive film is removed.

The invention relates to a pressure-sensitive adhesive film for gluing floor coverings onto a floor or a staircase.

Generally, pressure-sensitive adhesive tapes or films are already known. They are provided at the present time also for gluing floor coverings on a floor. At the present time, either wet adhesives or adhesive tapes are usually used for laying floor coverings on staircases. However, this results in enormously large adhesive residues when the floor covering is removed from the staircase.

The German patent application 198 35 919.5-43 discloses a pressure-sensitive adhesive film for gluing floor coverings on a floor, with a backing of a plastic film and a pressure-sensitive adhesive coating on the two surfaces. The pressure-sensitive adhesive film has a minimum width of 350 mm for covering large areas of the floor, on which the floor covering is to be laid. Within the scope of further optimizing the product with regard to using a pressure-sensitive adhesive film for gluing a floor covering on staircases or in spatially restricted regions of a floor, to which access is a difficult, it was found that, for such applications, the minimum width of the pressure-sensitive adhesive film of the German patent application 198 35 919.5-43 does not offer the best possible processability under all circumstances.

In general, when conventional pressure-sensitive adhesive tapes or films are used, the problem exists that, because of the materials used for the backing layer and/or the pressure-sensitive adhesive coating, there may, in the course of time, be various changes in the pressure-sensitive adhesive tapes, which have been put down, with effects on the respective use. For example, there may be migration from the pressure-sensitive adhesive or from the components of the pressure-sensitive adhesive, for example, through the backing and this may lead to changes in the properties of the adhesive, so that it is no longer possible to remove the latter without leaving a residue, or also to changes, such as color changes, in the floor. Furthermore, it is known that, when different pressure-sensitive adhesive adhesives are used to coat the lower and upper surfaces of the backing, there may be mixing of the pressure-sensitive adhesive adhesives used for the pressure-sensitive adhesive coating. If two different pressure-sensitive adhesive adhesives are used, mixing of these pressure-sensitive adhesive adhesives takes place over time; as a result, the gluing and/or release properties of a corresponding pressure-sensitive adhesive tape or film are changed correspondingly in an undesirable manner.

Moreover, when conventional pressure-sensitive adhesive tapes or films are used, the problem exists in general that the pressure-sensitive adhesive coating, when the pressure-sensitive adhesive tapes are removed from the floor and/or from the floor covering, in each case adhere more strongly to the floor or to the floor covering than to the backing layer. Admittedly, at least the floor covering can be removed from the floor once again under certain circumstances; however, removal of the corresponding pressure-sensitive adhesive tape or film without leaving a residue is not yet possible.

If floor coverings weighing more than 500 g/m² are to be used and especially glued, the additional problem arises that, under changing temperature and moisture conditions and the tendency to develop dimensional changes induced thereby, such floor coverings build up relatively high expansion and contraction forces. Reliable gluing therefore requires an appropriate pressure-sensitive adhesive tape or film having a high adhesive force. On the other hand, the residue-free detachability must not be impaired.

It is an object of the present invention to prepare a pressure-sensitive adhesive film for gluing floor coverings, especially for gluing a carpet on a floor or a staircase. The pressure-sensitive adhesive film is to overcome the disadvantages of the state of the art, offer reliable gluing, be easy to handle and to remove once again and, in particular, to offer residue-free detachability, at least from floors and staircases.

Pursuant to the invention, this objective is accomplished with a pressure-sensitive adhesive film of claim 1. Preferred further developments of the invention are defined in the dependent claims.

The inventive, pressure-sensitive adhesive film is used to glue a floor covering weighing more than 500 g/m², especially carpeting, to a floor or a staircase. The floor may be a parquet, terrazzo, stone, lime, carpeting or similar floor. The pressure-sensitive adhesive film has a backing of a plastic film, which is coated on an upper surface, facing the floor covering, and at a lower surface, facing the floor, with a pressure-sensitive adhesive coating. The inventive, pressure-sensitive adhesive film, with a minimum width of 150 mm is developed for covering the floor or the staircase over a large area with the floor covering, the backing, at least at its lower surface, being anchored by pressure-sensitive adhesive means in such a manner, when the pressure-sensitive adhesive film is detached, the pressure-sensitive adhesive coating remains at the lower surface of the supporting layer.

The inventive configuration of the pressure-sensitive adhesive film with a minimum width of 150 mm offers the possibility of handling the inventive pressure-sensitive adhesive film particularly flexibly, simply and reliably when covering large areas even under spatially restricted conditions.

Pursuant to the invention, it is particularly preferred that, when the inventive pressure-sensitive adhesive film is removed, the pressure-sensitive adhesive coating of the upper surface remains on the backing layer and, accordingly, a residue-free detachability becomes possible.

The residue-free detachability of the pressure-sensitive adhesive film from floors or from the staircase, as well as from the floor covering, is particularly advantageous, for example, if a floor covering in a trade fair construction is to be used once again after the exhibit stall has been taken down.

So that the anchoring of the pressure-sensitive adhesive coating on the backing is ensured under all conditions, at least the upper surface of the plastic film may be subjected preferably to a corona discharge treatment. This surface may furthermore also be provided with a primer coating. Suitable primers function, moreover, also as a retarding layer (see below), which prevents the passage of additives and/or plasticizers. In general, it is also possible to mix the primer with the pressure-sensitive adhesive coating of at least one of the surfaces.

Pursuant to a preferred embodiment, at least the lower surface of the pressure-sensitive adhesive film may have co-extruded adhesion promoters for anchoring the pressure-sensitive adhesive adhesive.

Pursuant to the invention, the surface of the backing layer, anchoring the pressure-sensitive adhesive adhesive, may also be constructed as a layer and/or the backing layer itself may consist of material anchoring the pressure-sensitive adhesive adhesive.

In general, it is possible to realize each of the above-described possibilities of the inventive, pressure-sensitive adhesive adhesive-anchoring construction at least of the lower surface of the pressure-sensitive adhesive film by itself or to combine two or more of these with one another, the pressure-sensitive adhesive adhesive-anchoring construction additionally also at least of the upper surface being possible, in the event that the residue-free detachability of the pressure-sensitive adhesive film from the floor or the staircase as well as from the floor covering is required.

Furthermore, the backing may be constructed so that it has at least a section as a layer retarding the passage of additives and/or plasticizers. Moreover, pursuant to a particularly preferred embodiment of the invention, the retarding layer may essentially be the pressure-sensitive adhesive adhesive-anchoring surface. In general, the additives and/or plasticizers may originate from the pressure-sensitive adhesive adhesives of the pressure-sensitive adhesive film itself or from the flooring used, such as PVC, and/or floor coverings.

Due to the construction of the backing layer with at least one section as a retarding layer, the migration and/or penetration of such additives and/or plasticizers is avoided, so that there can be no negative change in the properties of the pressure-sensitive adhesive coating originally present. Accordingly, it is ensured that the inventive, pressure-sensitive adhesive film retains the desired adhesive force over a longer period, and the detachability, especially the residue-free detachability, is not lost due to changes in the individual layers of the pressure-sensitive adhesive film.

It is furthermore advantageous, if at least the lower surface of the backing layer is constructed flat. Furthermore, it is advantageous if the pressure-sensitive adhesive coating is constructed essentially flat, at least at the lower surface. The essentially flat construction of at least the lower surface of the backing layer and/or of the pressure-sensitive adhesive coating ensures the particularly reliable glueability of the inventive pressure-sensitive adhesive film, a two-dimensional anchoring being achieved by avoiding adhesion centers, which occur due to punctiform stronger adhesion resulting from unevenesses. This improves handling of the inventive pressure-sensitive adhesive film and contributes to the essentially residue-free detachability of the inventive pressure-sensitive adhesive film from flooring and from staircases and/or from floor coverings.

To achieve a particularly reliable and durable gluing of the floor covering by means of the inventive pressure-sensitive adhesive film with, at the same time, a residue-free detachability from the flooring, is achieved, it is furthermore preferred if the lower surface of the pressure-sensitive adhesive coating has a lesser adhesive strength than the upper surface of the pressure-sensitive adhesive coating. For this purpose, different pressure-sensitive adhesive adhesives or the same pressure-sensitive adhesive may be used on each of the two surfaces.

In a preferred embodiment of the invention, the different adhesive strength or adhesive force of the two surfaces of the pressure-sensitive adhesive coating is brought about by applying different weights of adhesive, more adhesive being applied on the surface with the greater adhesive strength.

Particularly preferred is an embodiment, for which the weight of adhesive applied at least on the upper surface ranges from 5 to 250 g/m² and especially, at least on the lower surface, ranges from 5 to 40 g/m² and particularly from 8 to 20 g/m².

As pressure-sensitive adhesive adhesives, acrylate-based dispersions, enriched, for example, with resins and with the UV and aging protection contained therein, have proven their value. However, any other suitable pressure-sensitive adhesive dispersion adhesive can also be used, which can also be diffusible especially for water vapor. Preferably, the pressure-sensitive adhesive coating extends over the whole surface; it may, however, also be applied in sections.

Advisably, pressure-sensitive adhesive adhesives are selected, which have as constant an adhesive force as possible, over a certain period of time, in contact with the floor covering as well as in contact with the flooring.

Suitable pressure-sensitive adhesives, at least for the pressure-sensitive adhesive coating of the upper surface, may be resistant to plasticizers.

Suitable, detachable, pressure-sensitive adhesive adhesives, at least for the lower surface, have a G′/G″ ratio of at least 1. G′ preferably ranges from 8,000 Pa to 150,000 Pa and G″ preferably ranges from 4,000 Pa to 30,000 Pa

By suitably selecting the pressure-sensitive adhesive coating or the pressure-sensitive adhesive used, together with the backing layer, it is ensured pursuant to the invention that there is residue-free detachability of the inventive pressure-sensitive adhesive film, at least from the flooring, but, under certain circumstances, also from the floor covering, at any time.

Since pressure-sensitive adhesive adhesives with different adhesive forces can be applied on the surfaces, not only the weight of adhesive applied, but also the different adhesive forces of the pressure-sensitive adhesives used are responsible for the different adhesive strengths.

As a general method for measuring the adhesive strength or the adhesive force of a pressure-sensitive adhesive coating, the measurement of the peeling force according to DIN 1939 may be used. For this method, the force is measured, which is required for pulling off the pressure-sensitive adhesive film, which has been provided with pressure-sensitive adhesive coating of a particular adhesive force, which is to be investigated, and a particular application weight. According to the test standard, the width of the pressure-sensitive adhesive film is 25 mm and the pressure-sensitive adhesive film is glued to a steel surface.

Preferably, the peeling force of the pressure-sensitive adhesive coating at least of the lower surface, measured according to DIN 1939, ranges from 0.5 to 5 N. Preferably, it ranges from 1.5 to 3 N and especially from 2.0 to 2.6 N.

And as already mentioned, different pressure-sensitive adhesives, such as those with the different adhesive forces, or the same pressure-sensitive adhesive adhesives can be used on each of the two surfaces.

Pursuant to a preferred embodiment of the invention, the backing layer and the pressure-sensitive adhesive coating of the pressure-sensitive adhesive film are constructed to be permeable to water vapor, the s_{d} value ranging from 0.2 m to 15 m and especially from 0.5 to 7 m. The s_{d} value indicates the thickness of air in meters, which has an equivalent diffusion of water vapor. The s_{d} value of the water vapor permeability is measured by the ASTM E 398 method of Dr. Lyssy.

Due to the preferably water vapor-permeable construction of the inventive pressure-sensitive adhesive film, the possible accumulation of residual moisture, that is, water vapor, rising up from the flooring, especially in the case of freshly laid parquet or when laying floor coverings on a cement floor recently put down, which may not have dried out completely, between the flooring and the backing layer of the inventive pressure-sensitive adhesive film is prevented and, accordingly, the adhesion properties of the pressure-sensitive adhesive coating used are not affected negatively. In particular, a reduction in the adhesive force, as well as a possible inferior detachability can be avoided. Moreover, because of the appropriate configuration of the pressure-sensitive adhesive film when gluing a floor covering, there can been no mold formation or softening of the parquet, which may have been put down, due to accumulation of water vapor.

It may be advantageous to achieve the water vapor permeability of the backing layer and of the pressure-sensitive adhesive coating by perforating the backing layer and/or the pressure-sensitive adhesive coating at least at one of the surfaces. In this way, a water vapor permeability of the pressure-sensitive adhesive film can be achieved in a simple manner. However, the inventive perforation is not to be understood as implying that the pressure-sensitive adhesive film is merely prefabricated section-wise and that specified sections of the pressure-sensitive adhesive film can be severed by hand from the remaining pressure-sensitive adhesive film along appropriately extending perforation holes.

It is particularly preferred if the backing layer and/or the pressure-sensitive adhesive coating are provided with perforation holes, which are distributed over the whole area, of at least over one of the surfaces. Accordingly, especially if the inventive, pressure-sensitive adhesive film is used over large surfaces, the best possible water vapor permeability is provided.

In the event that the perforation holes in the backing layer and in the pressure-sensitive adhesive coating of at least one of the surfaces are aligned with one another, it is particularly advantageous if direct passage of any water vapor, rising up from the flooring, is possible.

Preferably, the perforation holes are at a distance from one another of preferably less than 10 cm, the holes having a cross-sectional area of preferably less than 4 mm².

Of course, it is possible, within the scope of the invention, to combine, for example, a perforated backing layer having a pressure-sensitive adhesive coating, which is perforated at least at one surface, with an imperforated, permeable pressure-sensitive adhesive coating on the respective other surface. Accordingly, the backing layer may be provided, for example, only on the upper or the lower surface with a perforated pressure-sensitive adhesive coating and, on the respectively other surface, have an imperforated permeable pressure-sensitive adhesive coating. The backing layer (perforated or not) may however also be provided at its upper as well as its lower surface with an imperforated or perforated pressure-sensitive adhesive coating, the perforation holes, in the event of a perforation, possibly being aligned with one another. Preferably, the pressure-sensitive adhesive coating of at least one of the surfaces may consist of a pressure-sensitive adhesive adhesive, through which water vapor can diffuse. However, both surfaces may also have a pressure-sensitive adhesive coating, perforated or not, which consists of a pressure-sensitive adhesive adhesive, through which water vapor can diffuse.

As already stated, it is advantageous if the backing layer, at least at its lower surface, is constructed essentially flat. Accordingly, in accordance with an advantageous embodiment of the invention, in the event that perforations are present, the backing layer and/or the pressure-sensitive adhesive coating of at least the lower surface can be constructed flat at least between the perforation holes; this is meant to be expressed by the expression “essentially flat”.

The particularly preferred embodiment of the pressure-sensitive adhesive film is prepared in that the perforation holes are punctured from below, that is, from the side of the lower surface, facing the flooring, into the pressure-sensitive adhesive film.

In this way, it is ensured that the inventive, pressure-sensitive adhesive film, at least at the lower surface of the backing layer, and that the pressure-sensitive adhesive coating, at least at the lower surface, are constructed essentially flat, since the burrs of the perforation holes of the backing layer, because the puncturing is directed in the upward direction away from the lower surface. Moreover, the pressure-sensitive adhesive coating at least of the lower surface essentially levels this.

At least at the upper surface, facing the floor covering, the inventive pressure-sensitive adhesive film, in a preferred embodiment, has a fabric/nonwoven or a textile structure, which serves to maintain the dimensional stability to the pressure-sensitive adhesive film, while it is being laid down or detached. The fabric may also be disposed at the lower surface, facing the flooring or at both surfaces. The fabric is formed by yarns of a suitable, tear-resistant material.

The arrangement may assume any, essentially coarse mesh configuration. In particular, yarns, which are disposed at right angles to one another and are parallel to one another in the respective direction, are preferred. The yarns may be aligned parallel to the side edges of the pressure-sensitive adhesive film in the respective directions or form any angle with these edges.

Particularly preferred is an embodiment, for which the textile structure has parallel yarns in a coarse mesh arrangement as well as yarns, disposed diamond-shaped at an obtuse angle.

It is particularly preferred if the distance between the yarns of the textile structure is between 3 and 30 mm.

The textile structure may be a nonwoven material or also a net-like, spun structure, for which the yarns consist of fine individual yarns, which are spun together. The yarns of the textile structure are at least on the upper surface of the backing layer and are embedded in the pressure-sensitive adhesive coating and essentially surrounded by the latter, so that the corresponding surface of the pressure-sensitive adhesive film is also constructed essentially flat. The coarse-mesh, textile structure ensures dimensional stability of the pressure-sensitive adhesive film, the essentially flat construction of the corresponding surface also being essentially retained. This facilitates the reliable detachment, since the pressure-sensitive adhesive film remains dimensionally stable during the detachment.

Due to the particularly preferred parallel as well as diamond-shaped arrangement of the yams, there is additional dimensional stability in an inclined direction, that is, in the direction of the yarns disposed in diamond-shaped fashion. This additional stability is advantageous particularly when the pressure-sensitive adhesive film is pulled off at an angle (in relation to the yarns disposed parallel to the edges) and offers additional reliability for the residue-free detachment of the pressure-sensitive adhesive film.

In order to improve the handling of the inventive pressure-sensitive adhesive film, the latter has, at least at the upper surface on its pressure-sensitive adhesive coating, a removable covering film. The latter may consist, for example, of silicone paper or of a different suitable material.

There may also be a removable covering film additionally or only on the lower surface. This is not absolutely necessary in the event that the adhesive strength of the lower surface is less than that of the upper surface.

The covering film, detachably adherent, lies practically without gaps in contact with the corresponding upper surface.

The pressure-sensitive adhesive film may be transported in the form of rolls. For this purpose, the pressure-sensitive adhesive film is wound up into a roll. In general, the pressure-sensitive adhesive film can be unwound in the desired length from the roll. The pressure-sensitive adhesive film can be prefabricated in a particular width and also in particular lengths and/or shapes.

In order to achieve the best possible gluing results, it is particularly advantageous if the pressure-sensitive adhesive film is constructed so that it covers large areas of the flooring or the staircase, which is to be covered with the floor covering.

In this connection, it is particularly advantageous that the width of the pressure-sensitive adhesive film ranges from 150 mm to 2,000 mm, especially from 500 mm to 1,500 mm and particularly from 600 mm to 1,000 mm. For staircases, a pressure-sensitive adhesive film with a width of 240 mm and, for flooring, a pressure-sensitive adhesive film with a width of at least 350 mm are particularly preferred.

In this connection, the width is defined as the unwinding width of the roll (roll width) in the case of a pressure-sensitive adhesive film, which is rolled up into a roll.

By selecting a pressure-sensitive adhesive film of suitable width, it is possible, in particular, to achieve coverage of the flooring, which is to be glued with the pressure-sensitive adhesive film, over a large area and, accordingly, make a particularly simple and reliable gluing possible. The preferred width of 240 mm, when the pressure-sensitive adhesive film is used on staircases, is selected so that the pressure-sensitive adhesive film can cover, largely or completely, the tread as well as the riser of a step with normal dimensions in two pieces. In each case, a piece of pressure-sensitive adhesive film, cut to a suitable size, can be applied on the tread and on the riser of the step, their respective edges meeting or overlapping slightly in the region of the edge of the step and, accordingly, form a gap-free adhesive surface. Extensive or complete coverage of the surface by the pressure-sensitive adhesive film can also be achieved if a pressure-sensitive adhesive film of lesser width is selected. In such a case, however, more than one piece of pressure-sensitive adhesive film, cut to a suitable size, is required. More than two pieces can then be cut to suitable dimensions and also, for example, placed around the edge of the step.

The inventive, pressure-sensitive adhesive film is used preferably in the following way for gluing a floor covering.

As far as possible, the whole of the flooring is covered, without gaps, with the pressure-sensitive adhesive film. In so doing, the lower surface, which preferably has the lesser adhesive strength, is directed in the direction of the flooring. The upper surface preferably is covered with the covering film. The floor covering is then laid down provisionally and, optionally, cut to size. Subsequently, a portion of the floor covering is folded back and the covering film on this part of the pressure-sensitive adhesive film is removed. The folded-backed part of the floor covering is folded once again onto the upper surface, which preferably has the greater adhesive strength, and optionally pressed down. The procedure with the remaining parts of the floor covering is the same, until a whole of the floor covering is glued to the flooring.

For the preferred, residue-free detachment of the floor covering from the flooring, the floor covering need only be pulled upward from the flooring. In so doing, the pressure-sensitive adhesive film separates from the flooring and, preferably, continues to adhere to the floor covering. At the same time, the pressure-sensitive adhesive coating of the lower surface remains at the backing layer. Additionally, it is also possible that the inventive, pressure-sensitive adhesive film is configured so that it can be detached from the floor covering and that the pressure-sensitive adhesive coating of the upper surface remains at the backing. Accordingly, when the floor covering is used, for example, in trade fairs, it can be used again without the ability to handle it being limited by adhesive residues, which may be at its underside.

Plastic film, particularly of polypropylene or polyethylene, is used as the material for the backing layer. If the backing layer is to be permeable, preferably to water vapor, it may consist, for example, of a polyamide film.

In order to provide good handling of the inventive, pressure-sensitive adhesive film, particularly also when it is perforated, the backing layer has a thickness ranging from 10 to 100 μm, preferably from 25 to 75 μm and particularly from 50 to 70 μm.

1. A pressure-sensitive adhesive film for gluing floor coverings with a weight of more than 500 g/m², especially a carpeted floor on flooring, particularly on parquet or on staircases, with a backing layer of a plastic film, which is coated at an upper surface, facing the floor covering, and at a lower surface, facing the flooring or the staircase, with a pressure-sensitive adhesive coating, and with a minimum width of 150 mm for covering large areas of the flooring or the staircase, which is to be covered with a floor covering, the backing being constructed at least at its lower surface to anchor the pressure-sensitive adhesive adhesive, so that, when the pressure-sensitive adhesive film is detached, the pressure-sensitive adhesive coating remains at the lower surface of the backing layer.

2. The pressure-sensitive adhesive film of claim 1, wherein the pressure-sensitive adhesive coating of the upper surface remains at the backing layer when the pressure-sensitive adhesive film is detached.

3. The pressure-sensitive adhesive film of claims 1 or 2, wherein at least the lower surface of the backing layer is subjected to a corona discharge treatment.

4. The pressure-sensitive adhesive film of one of the claims 1 to 3, wherein at least the lower surface of the backing layer is provided with a primer coating.

5. The pressure-sensitive adhesive film of one of the claims 1 to 4, wherein at least the lower surface of the backing layer has a co-extruded adhesion promoter.

6. The pressure-sensitive adhesive film of one of the claims 1 to 5, wherein the adhesive-anchoring surface is constructed as a layer.

7. The pressure-sensitive adhesive film of one of the claims 1 to 6, wherein the backing consists of an adhesive-anchoring material.

8. The pressure-sensitive adhesive film of one of the claims 1 to 7 wherein the backing layer has at least one section as a retarding layer to prevent penetration of additives and/or plasticizers.

9. The pressure-sensitive adhesive film of claim 8, wherein the retarding layer essentially is the pressure-sensitive adhesive adhesive-anchoring surface.

10. The pressure-sensitive adhesive film of one of the claims 1 to 9, wherein at least the lower surface of the backing layer is constructed essentially flat.

11. The pressure-sensitive adhesive film of one of the claims 1 to 10, wherein at least the pressure-sensitive adhesive coating of the lower surface is constructed essentially flat.

12. The pressure-sensitive adhesive film of one of the claims 1 to 11, wherein the adhesive strength of the pressure-sensitive adhesive coating of the lower surface is less than that of the upper surface.

13. The pressure-sensitive adhesive film of claim 12, wherein the different weights of adhesive are applied at two surfaces in order to achieve different adhesive strengths, the surface with the greater adhesive strength having more adhesive.

14. The pressure-sensitive adhesive of claim 13, wherein the weight of adhesive applied at least to the upper surface ranges from 5 to 250 g/m² and that applied especially to the lower surface ranges from 5 to 40 g/m² and particularly from 8 to 20 g/m².

15. The pressure sensitive adhesive film of one of the claims 1 to 14, wherein an at least the pressure-sensitive adhesive coating at the upper surface consists of a plasticizer-resistant pressure-sensitive adhesive adhesive.

16. The pressure sensitive adhesive film of one of the claims 1 to 15, wherein at least the pressure-sensitive adhesive coating at the lower surface consists of a pressure-sensitive adhesive with a G′/G″ ratio of not less than 1.

17. The pressure-sensitive adhesive film of one of the claims 1 to 16, wherein the pressure-sensitive adhesive coating consists of different pressure-sensitive adhesives on the upper and the lower surface.

18. The pressure-sensitive adhesive film of one of the claims 1 to 17, wherein at least the lower surface has an adhesive strength (measured by the peel force according to DIN 1939) of the order of 0.5 to 5N, particularly of 1.5 to 3 N and especially of 2.0 to 2.6 N.

19. The pressure-sensitive adhesive film of one of the claims 1 to 18, wherein the backing and the pressure-sensitive adhesive coating are permeable to water vapor, having an s_{d} value ranging from 0.2 m to 15 m and especially from 0.5 to 7 m.

20. The pressure-sensitive adhesive film of claim 19, wherein the backing and/or the pressure-sensitive adhesive coating of at least one surface is/are perforated with perforation holes, which are distributed over the whole surface at a distance preferably of less than 10 cm from one another and have a cross-sectional area of less than 4 mm².

21. The pressure-sensitive adhesive film of claim 20, wherein the perforation holes in the backing layer and the pressure-sensitive adhesive coating are aligned at least in one of the surfaces.

22. The pressure sensitive adhesive film of one of the claims 1 to 21, wherein the pressure-sensitive adhesive film has a textile structure at least on the upper surface.

23. The pressure-sensitive adhesive film of claim 22, wherein the textile structure has yarns in a coarsely meshed arrangement.

24. The pressure-sensitive adhesive film of claim 23, wherein the textile structure has parallel yarns in a coarsely meshed arrangement, as well as yarns, which are disposed in diamond shape and at an obtuse angle.

25. The pressure-sensitive adhesive film of one of the claims 22 to 24, wherein the textile structure has yarns at a distance of 3 to 50 mm from one another.

26. The pressure-sensitive adhesive film of one of the claims 1 to 25, wherein a removable covering film is present on at least the upper surface.

27. The pressure-sensitive adhesive film of one of the claims 1 to 26, wherein its width ranges from 150 mm to 2000 mm, particularly from 500 mm to 1,500 mm and especially from 600 mm to 1,000 mm, the width being, in particular, 240 mm when used for staircases and an at least 350 mm when used on flooring.

28 the pressure-sensitive adhesive film of one of the claims 1 to 27, wherein the backing layer has a thickness ranging from 10 to 100 μm, preferably from 25 to 75 μm and especially from 50 to 70 μm.

29. The pressure-sensitive adhesive film of one of the claims 1 to 28, wherein the pressure-sensitive adhesive film is wound up into a roll.
